(19) United States
(12) Patent Application Publication
(10) Pub. No.: US 2026/0017755 A1
(43) Pub. Date: Jan. 15, 2026

(54) METHOD AND SYSTEM FOR GENERATING REAL-TIME TARGET VIDEO

(71) Applicant: Nanjing Silicon Intelligence Technology Group Co., Ltd, Nanjing (CN)

(72) Inventors: Hua Peng SIMA, Nanjing (CN); Hao JIANG, Nanjing (CN)

(73) Assignee: Nanjing Silicon Intelligence Technology Group Co., Ltd, Nanjing (CN)

(21) Appl. No.: 19/269,069

(22) Filed: Jul. 15, 2025

(30) Foreign Application Priority Data
Jul. 15, 2024 (CN) 202410939073.0

(51) Int. Cl. G06T 3/4046; G06T 3/4053

(52) U.S. Cl. CPC G06T 3/4046; G06T 3/4053

(57) ABSTRACT

A method and a system for generating real-time target video are provided, the method includes: acquiring training data including interactive information and video data corresponding to the interactive information; preprocessing the training data to obtain target training data; where the preprocessing includes: performing down-sampling processing on the video data to obtain a plurality of frames of low-resolution images; performing model training to a preset model based on the target training data; the model training includes a model pre-training process and a video pre-generation process, the model pre-training process includes a training of a low-resolution image reconstruction model and a training of a super-resolution model, and the video pre-generation process includes: performing video pre-generation based on the target training data and an interactive video generation model to complete training to the interactive video generation model; and, obtaining an interactive target video through the trained interactive video generation model and input data.

### CROSS-REFERENCE TO RELATED APPLICATIONS

The present application claims priority to and the benefit of Chinese Patent Application No. 202410939073.0, filed on Jul. 15, 2024, the disclosures of which is incorporated herein by reference in its entirety.

### TECHNICAL FIELD

The present disclosure relates to the field of deep learning technology, and in particular relates to a method and a system for generating real-time target video.

### BACKGROUND

With the rapid development of information technology, video generation and processing technology has become a major research hotspot in contemporary science and technology. Among many video processing techniques, the interactive video generation method is particularly noteworthy. This method can not only realize the basic functions of traditional video production, but also give users the ability to interact with the video content in real time, which greatly enriches the scenarios and possibilities of video applications.

In the current research, video generation techniques mainly include the following two kinds of Schemes, Scheme 1 of which is to obtain a video image corresponding to text information through generating a frame of video based on the text information through a neural network by importing the text information into the neural network, and obtaining each of following frames in the same manner; and Scheme 2 of which is to obtain a video image by acquiring a temporal noise and importing the temporal noise into a 3D generation model.

However, the generated video content is fixed regardless of whether Scheme 1 or Scheme 2 is used, i.e., each frame of image is pre-determined and cannot be dynamically adjusted according to real-time interactive operations. In addition, most of the existing techniques provide output in the form of video files, which may not implement the generation of real-time video streams, and is particularly insufficient in the scenarios that require immediate feedback and high interactivity.

### SUMMARY

The present application provides a method and a system for generating real-time target video to solve a problem that existing video generation techniques cannot be adjusted interactively in real time.

In a first aspect, the present application provides a method for generating real-time target video, including:
acquiring training data including interactive information and video data corresponding to the interactive information;
preprocessing the training data to obtain target training data; where the preprocessing includes: performing down-sampling processing on the video data to obtain a plurality of frames of low-resolution images; where the target training data is used to indicate the low-resolution images and the interactive information corresponding to the low-resolution images;
performing model training to a preset model based on the target training data, where the preset model includes a low-resolution image reconstruction model and a super-resolution model for images; the model training includes a model pre-training process and a video pre-generation process, the model pre-training process includes a training of a low-resolution image reconstruction model and a training of a super-resolution model, and the video pre-generation process includes: performing video pre-generation based on the target training data and an interactive video generation model to complete training to the interactive video generation model, where the interactive video generation model includes the pre-trained low-resolution image reconstruction model and the pre-trained super-resolution model for images; and
obtaining an interactive target video through the trained interactive video generation model and input data.

In a second aspect, the present application further provides a system for generating real-time target video, including:
a data acquisition module, configured to acquire training data including interactive information and video data corresponding to the interactive information;
a data preprocessing module, configured to preprocess the training data to obtain target training data; where the preprocessing includes: performing down-sampling processing on the video data to obtain a plurality of frames of low-resolution images; where the target training data is used to indicate the low-resolution images and the interactive information corresponding to the low-resolution images;
a model training module, configured to perform model training to a preset model based on the target training data, where the preset model includes a low-resolution image reconstruction model and a super-resolution model for images; the model training includes a model pre-training process and a video pre-generation process, the model pre-training process includes a training of a low-resolution image reconstruction model and a training of a super-resolution model, and the video pre-generation process includes: performing video pre-generation based on the target training data and an interactive video generation model to complete training to the interactive video generation model, where the interactive video generation model includes the pre-trained low-resolution image reconstruction model and the pre-trained super-resolution model for images; and
a video generation module, including the trained interactive video generation model, where the trained interactive video generation model includes the trained resolution image reconstruction model and the trained super-resolution model, where the video generation module is configured to obtain an interactive target video through the trained interactive video generation model and input data.

As can be seen from the foregoing, the present application provides a method and a system for generating real-time target video, where the method includes: acquiring training data including interactive information and video data corresponding to the interactive information; preprocessing the training data to obtain target training data; where the preprocessing includes: performing down-sampling processing on the video data to obtain a plurality of frames of low-resolution images; where the target training data is used to indicate the low-resolution images and the interactive information corresponding to the low-resolution images; performing model training to a preset model based on the target training data, where the preset model includes a low-resolution image reconstruction model and a super-resolution model for images; the model training includes a model pre-training process and a video pre-generation process, the model pre-training process includes a training of a low-resolution image reconstruction model and a training of a super-resolution model, and the video pre-generation process includes: performing video pre-generation based on the target training data and an interactive video generation model to complete training to the interactive video generation model, where the interactive video generation model includes the pre-trained low-resolution image reconstruction model and the pre-trained super-resolution model for images; and, obtaining an interactive target video through the trained interactive video generation model and input data. The problem that existing video generation techniques cannot perform real-time interaction can be solved by the present application.

### BRIEF DESCRIPTION OF THE DRAWINGS

In order to clearer describe the technical solutions of the present application, the accompanying drawings for the embodiments will be briefly described below, and it will be obvious to a person of ordinary skill in the art that other accompanying drawings may be derivable based on these drawings without creative labor.

FIG. 1 is a flowchart illustrating a method for generating real-time target video of the present application;

FIG. 2 is a schematic diagram illustrating data processing for training a low-resolution image reconstruction model and a super-resolution model in a method for generating real-time target video of the present application;

FIG. 3 is a schematic diagram illustrating data processing for training an interactive video generation model in a method for generating real-time target video of the present application;

FIG. 4 is a schematic diagram illustrating data processing by a transformer in the training of an interactive video generation model of the present application;

FIG. 5 is a schematic diagram illustrating a system for generating real-time target video of the present application.

### DETAILED DESCRIPTION

The technical solutions in the embodiments of the present disclosure will be clearly and completely described below in conjunction with the accompanying drawings in the embodiments of the present disclosure, and it is clear that the described embodiments are only a part, not all, of embodiments of the present invention. Based on the embodiments in the present disclosure, all of other embodiments derivable by a person of ordinary skill in the art without making creative labor fall within the scope of protection of the present invention.

In a particular interactive scene, the acquired continuous interactive operation is used for the generation of a continuous video image, where the generated video image contains content matched with the interactive operation. The above interactive scenarios include, but are not limited to, scenarios such as clicking by a keyboard or a mouse, operating by a gamepad, voice control, motion capture by a somatosensory device, motion capture by a photographic device, or a brain-computer interface. The above video image and content are generated by the above interaction, the change of which occurs following the change of the above interaction, including but not limited to video content such as game image, scene guide, and the like.

For example, in a certain game, keyboard arrow keys are used to provide operations, where corresponding game images are generated as keyboard inputs change; continuous keyboard inputs and corresponding image content are captured to train an interactive video generation model; continuous keyboard interactions are fed into the interactive video generation model to generate continuous image content, i.e., video content, which is related to a specific scene, that is, a certain interactive video generation model may generate video content for a specific scene. If it is needed to generate video content for a new scene, it is needed to re-collect data and train a new interactive video generation model.

At present, existing techniques of generating video include following schemes.

In a first scheme, an existing video generation process includes steps (1) inputting text information into a Decoder model of a Transformer neural network, encoding the text information, and generating an encoding feature of a corresponding frame image; (2) decoding the encoding feature of the frame image into a current frame image using the Decoder model of a VQVAE neural network; (3) down-sampling and inputting the generated current frame image into the Encoder model of VQVAE neural network to obtain the encoding information of the generated image; (4) inputting the text information and the encoding information of the generated image into the Decoder model of the Transformer neural network to obtain an encoding feature of a corresponding next frame image; and (5) repeating the steps (2) to (4) until a preset number of frames are reached to output a complete video.

In a second scheme, a process of generating the video includes: steps (1) randomly sampling a temporal noise, inputting the temporal noise into a 3D generator model similar to structures of StyleGAN2 and StyleGAN3 through a mapping network, and up-sampling an initial input from the temporal dimensions and spatial dimension, respectively, by the 3D generator model, so as to generate a low-resolution video; and (2) inputting the low-resolution video generated from step (1) into a video super-resolution model to obtain a generative video with a high-resolution.

In a third scheme, video generation is performed by using textual information as a condition, or an unconditional video generation may also be performed. The third scheme for video generation uses a diffusion model with a backbone of 3D-UNet to sample noise from a standard Gaussian distribution for stepwise denoising to finally obtain the generative video. In the stepwise denoising process, language models, such as pre-trained BERT, CLIP, etc., may be used to extract textual features from given textual information, and the textual features are injected into the 3D-UNet using the self-attention mechanism to provide textual condition guidance for video generation. Of course, it is also possible to perform the unconditional video generation without using textual information.

According to the above schemes, it may be known that: the first scheme is directed to a conditional video generation using textual information, the second scheme is directed to an unconditional video generation without using other information, and the third scheme is directed to a scheme in which both a conditional video generation using textual information and unconditional video generation without using other information may be performed. In the above method, in the event that the textual information or an initial state is given, the content of the generative video is fixed, that is, each of frame images of the generative video is fixed. Each of the frame images of the generative video is only related to the initial input, and no process can be performed by the above method when the input changes during the generation process, that is, an interactive occurs. Meanwhile, the output of the second scheme and the output of the third scheme are in the form of a video, which is not capable of generating a real-time video stream.

Based on the foregoing, the present embodiments provide the following solutions to solve the above problems.

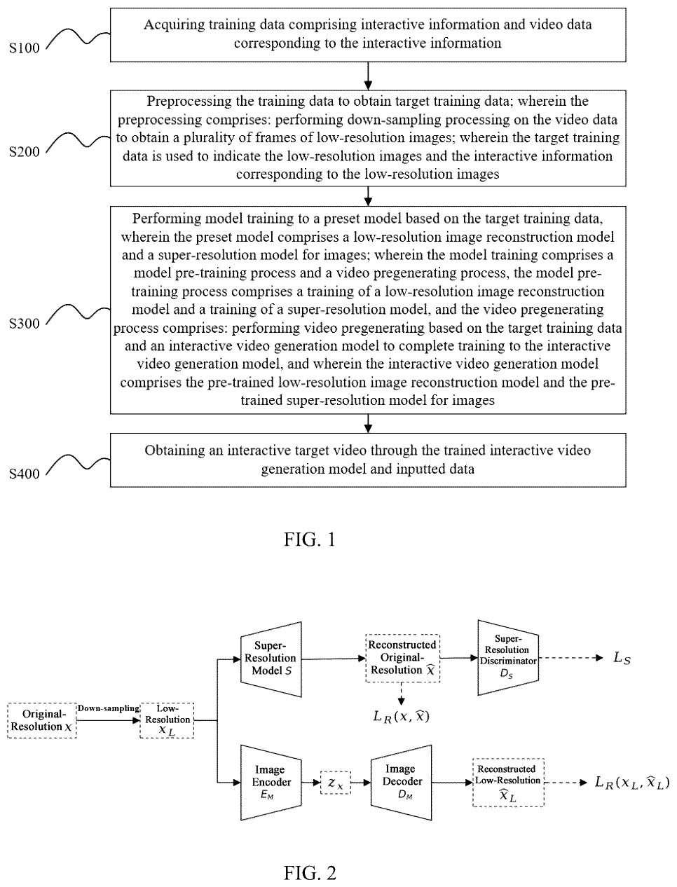

FIG. 1 is a flowchart illustrating a method for generating real-time target video of the present application.

Referring to FIG. 1, it can be seen that the present embodiment provides a method for generating real-time target video, including:

S100, acquiring training data including interactive information and video data corresponding to the interactive information. Specifically, in the present embodiment, the training data is continuous interactive information and video data corresponding to the interactive information. The interactive information involves, but is not limited to, keyboard or mouse clicks, gamepad operation, voice control, motion capture by a somatosensory device, motion capture using a photographic device, a brain-computer interface, or the like. All the interactive information is captured directly by some external device; or data is first captured by some external device, and then the interactive information is extracted from the captured data by relevant software or algorithms. The video data corresponding to the interactive information refers to the video generated by the above interaction process, and changes occurred in the above interaction process may correspond to changes in video content. Taking a racing game as an example, keyboard operation may control movements of objects in the game image, and when the keyboard operation changes, content of the game image will change accordingly.

When acquiring training data, it is needed to record both interactive operation information and video image data. A duration of the video for training is as long as possible, not less than 10 minutes, which is not limited thereto. A video resolution may be a common resolution, such as 360P, 480P, 720P, 1080P, etc., but not mandatory. Video frame rate may be a common video frame rate at present, such as 25 frames per second (fps) or 30 fps, not mandatory. Meanwhile, the interactive operation information synchronized with the video may be recorded, where the frame rate of the interactive operation information is not lower than the video frame rate, and is an integer times of the video frame rate. For example, if the recorded video frame rate is 30 fps, the frame rate of the recorded interactive operation information may be 30 fps, 60 fps, 90 fps, 120 fps or the like.

S200, preprocessing the training data to obtain target training data; where the preprocessing includes: performing down-sampling processing on the video data to obtain a plurality of frames of low-resolution images; where the target training data is used to indicate the low-resolution images and the interactive information corresponding to the low-resolution images. Specifically, in the present embodiment, in order to facilitate a subsequent model training, it is needed to first preprocess the training data, where the preprocessing the training data includes:

down-sampling the video data to obtain a low-resolution image, where a ratio of the down-sampling for reducing resolution is determined according to a size of a frame image of the video data; cropping the low-resolution images to obtain several groups of video clips, where each of the video clip includes T frames, a stride of T/2 frames is presented between adjacent two of the video clips, and adjacent two of the video clips overlap by T/2 of frames; recording corresponding interactive information for each of the video clips to obtain the target training data, where a frame rate of the interactive information recorded for each of the video clips is not less than a number of frames of the corresponding video clip, and the frame rate of the interactive information recorded for each of the video clips is an integer times of the number of the frames of the corresponding video clip.

Exemplarily, in order to train an image reconstruction model and a super-resolution model S, it is needed to extract images of all the frames from the captured video, and the frame images have the same resolution as that of the video, which is denoted as an original-resolution x herein. A down-sampling operation at a certain ratio is performed for the original-resolution x to obtain a low-resolution x_{L}. A certain down-sampling ratio needs to be determined according to the size of the frame image. For example, if the video frame image is 360P or 480P, the down-sampling ratio is 2, i.e., a length and width of the low resolution x_{L} after the down-sampling is ½ of the length and width of the original-resolution x. If the video frame image is 720P or 1080P, the down-sampling ratio is ¼, i.e., the length and width of the low resolution x after the down-sampling is of the length and width of the original-resolution x. The higher the resolution of the original image, the higher the down-sampling ratio.

It should be noted that the low-resolution x_{L} and the original-resolution x are in the form of images.

To train the interactive video generation model, the original video needs to be cropped into a number of clips each with an image portion denoted as v inlcuding a set of frame images [x¹, . . . , x^{t}, . . . , x^{T}], where T is a number of frames contained in each video clip, and t is an index of the frame image in the video clip. When cropping a video into clips, each clip contains T frames, a stride of T/2 frames is presented between adjacent video clips, and adjacent video clips overlap by T/2 frames. The interactive operation information corresponding to the video clip v is I=[I¹, . . . . I^{t}, . . . , I^{T}]. Each frame image x^{t} has its corresponding interactive operation I^{t}. Since the frame rate of the interactive operation information is not lower than the video frame rate, and is an integer times (denoted as N) of the video frame rate when recording data, then each frame of video images corresponds to a set of interactive operations

$${I}^{t} = [ {I}_{1}^{t} , {I}_{2}^{t} , … , {I}_{n}^{t} , … , {I}_{N}^{t} ] ,$$

where n is an index of the interactive operation information corresponding to the frame image x^{t}, and

$${I}_{n}^{t}$$

is an interactive information vector. Due to the diversity of interactive forms, the

$${I}_{n}^{t}$$

may be discrete or may also be continuous. For example, when the interactive information is collected from keyboard or mouse clicks, or gamepad operations, the interactive information is represented as a discrete value indicating whether the key is clicked or not, and by this time

$${I}_{n}^{t}$$

is a vector of a set of one-hot codes; and when the interactive information is collected from voice control, motion capture by a somatosensory device, motion capture by a photographic device, or a brain-computer interface, the interactive information is represented as a set of continuous values. The f represents a number of features of the vector

$${I}_{n}^{t} ,$$

the I^{t} represents a f×N matrix. In order to unify the discrete interactive operation information and the continuous interactive operation information, in the present embodiment, Gaussian smoothing is performed on I^{t} in a temporal dimension (i.e. N) to transform the discrete interactive information into continuous interactive information, so as to realize that continuous interactive information may be obtained for training and inference in various interactive manners.

For certain more complex interactive manners, such as voice control, motion capture by a somatosensory device, motion capture by a photographic device, or a brain-computer interface, etc., raw data captured by itself may include acoustic signals, images, electrical signals, etc., a process of processing the raw data captured by each of the complex interactive manners is not included in a process of data preprocessing according to the present embodiment. The information generated after the raw data is processed by the interactive manners themselves is used for the data preprocessing for the interactive operation information in the present embodiment. For example, when using speech control as an interactive manner, acoustic signals are not directly used in the present embodiment, but are processed by some existing methods, and processed acoustic features are used as interactive operation information.

S300, performing model training to a preset model based on the target training data, where the preset model includes a low-resolution image reconstruction model and a super-resolution model for images; the model training includes a model pre-training process and a video pre-generation process, the model pre-training process includes a training of a low-resolution image reconstruction model and a training of a super-resolution model, and the video pre-generation process includes: performing video pre-generation based on the target training data and an interactive video generation model to complete training to the interactive video generation model, where the interactive video generation model includes the pre-trained low-resolution image reconstruction model and the pre-trained super-resolution model for images. Specifically, in the present embodiment, step S300 is a step of model training, and the model pre-training process is divided into two phases including: (1) a pre-training process including the training of the low-resolution image reconstruction model, and the training of the super-resolution model S, and (2) the training of the interactive video generation model, through generating images frame by frame, the generated images may all be merged to generate a video or may also be output in real time into a video stream. There is no sequential requirement for the trainings of two models in the pre-training process. The pre-training process needs to be performed before the training of the interactive video generation model.

FIG. 2 is a schematic diagram illustrating data processing for training a low-resolution image reconstruction model and a super-resolution model in a method for generating real-time target video of the present application.

Referring to FIG. 2, it can be seen that the training of the low-resolution image reconstruction model includes the following scheme.

An image encoder E_{M} and an image decoder D_{M} are involved, and the low-resolution image reconstruction model includes basic neural network structures such as a convolutional layer, a fully connected layer, an activation layer, a pooling layer, and a normalization layer. Some existing network structures may be used, for example, neural networks with encoder and decoder structures, such as AutoEncoder, VAE, and VQVAE; or the image reconstruction model may also be self-designed by using the basic structures. The specific structure of the neural network is not required here.

For the low-resolution image reconstruction model, a low-resolution x_is used as input, a hidden-layer encoding zₓ of the input low-resolution x_{L} is obtained through an image encoder E_{M}, and the hidden-layer encoding zₓ is input into the image decoder D_{M} to obtain a reconstructed low-resolution \hat{x}_{L}, where it is desired that the reconstructed image \hat{x}_{L} is as identical as possible to the input image x_{L}. The hidden-layer encoding zₓ generated by the image encoder E_{M} in this process may be used to characterize the input image, which is subsequently used for the training and inference of an interactive video generation model.

To train the low-resolution image reconstruction model, a real low-resolution x_{L} is used as input and also as supervisory data, and through the image encoder E_{M} and image decoder D_{M}, the reconstructed low-resolution \hat{x}_{L} image is output from the model, and a reconstruction loss function L_{R}(x_{L}, \hat{x}_{L}) is calculated. The reconstruction loss function is a loss function using MAE loss (L₁ loss), MSE loss (L₂ loss), perceptual loss, image similarity loss, or any other loss function that may characterize an image difference. After the reconstruction loss function is calculated, a back propagation process is performed. Based on the calculated loss function, a gradient is calculated for parameters of each component of the image encoder E_{M} and the image decoder D_{M}, where a gradient descent method is used to optimally update the parameters of each component in the low-resolution image reconstruction model. The model pre-training process involves several rounds, the above model pre-training process is performed in each round until the training termination conditions are reached, so as to complete the training of the model.

It should be noted that the loss function to be calculated may be different according to different neural networks.

Referring to FIG. 2, it can be seen that training of the super-resolution model S includes the following scheme.

The super-resolution model S may process the input low-resolution image to obtain a high-resolution image corresponding to the content of the low-resolution image to improve definition of the input low-resolution image. The super-resolution model S includes basic structures of a neural network such as a convolutional layer, a fully connected layer, an activation layer, a pooling layer, and a normalization layer. Existing neural networks for super-resolution tasks may be used as the super-resolution models S, or a super-resolution model S self-designed by using the basic structures may also be used. The specific structure of the neural network is not required herein. The existing super-resolution models S include, but are not limited to, HAT, SwinIR, LTE, etc.

The super-resolution model S internally contains a series of up-sampling layers that use low-resolution x_{L} as input. After up-sampling, a reconstructed original-resolution \hat{x} is output, where it is desired that the resolution of the reconstructed image \hat{x} is as identical as possible to the real original-resolution x.

To train the super-resolution model S, a real low-resolution x_{L} is used as input, and an original-resolution x corresponding to the real low-resolution x_{L} is used as supervisory data. Through the super-resolution model S, the reconstructed original-resolution \hat{x} is output, and a reconstruction loss L_{R}(x, \hat{x}) is calculated, where a reconstruction loss function may use MAE loss (L₁ loss), MSE loss (L₂ loss), perceptual loss, image similarity loss, or any other loss function that may characterize an image difference. The reconstruction loss function is optimized to ensure that the reconstructed image output from the super-resolution model S has the same content as the real original-resolution image.

It should be noted that the reconstruction original-resolution \hat{x} is in the form of an image.

By optimizing the super-resolution discriminator D_{S}, it is determined whether the input image is a real image or a reconstructed image, so that the definition of the reconstructed image output from the super-resolution model S is close to the definition of the real image. The super-resolution discriminator D_{S} may optimize the super-resolution model S, so that the image output from the super-resolution model S is closer to the real image. The super-resolution discriminator D_{S} includes the basic structures of neural network such as a convolutional layer, a fully connected layer, an activation layer, a pooling layer and a normalization layer. The structure of a discriminator of an existing generative adversarial network may be used, or the discriminator may be self-designed by using a basic structure.

The super-resolution discriminator D_{S} is used for determining whether the input image is a real original-resolution image or a reconstructed original-resolution image, and is a binary classification model, and therefore, it is sufficient to use a commonly used cross-entropy loss function. The cross-entropy loss function L_{S} is as shown in formula (1), where xᵢ denotes an image input into a super-resolution discriminator D_{S}, and yᵢ denotes a label of the image. When the image xᵢ input to the super-resolution discriminator D_{S} is a real original-resolution image, yᵢ is 1; and when the image input to the super-resolution discriminator D_{S} is a reconstructed original-resolution image, yᵢ is 0. D_{S}(xᵢ) denotes an output of the super-resolution discriminator D_{S} after the image is input into the super-resolution discriminator D_{S}, a value of D_{S}(xᵢ) indicates a probability that the input image is a real image. In addition to the cross-entropy loss function for classification of the discriminator, other loss functions for classification may also be used.

$${L}_{S} = - {y}_{i} log ( {D}_{s} ( {x}_{i} ) ) - ( 1 - {y}_{i} ) log ( 1 - {D}_{s} ( {x}_{i} ) ) \qquad Formula ( 1 )$$

The above reconstruction loss L_{R} and the cross-entropy loss for the discriminator are calculated, and a back propagation process is carried out. Based on the calculated loss function, the gradient is calculated for the parameters of each component in the model, where the parameters of each component in the model are optimally updated using a gradient descent method. It should be noted that the above reconstruction loss L_{R} is used to optimize only the parameters of the super-resolution model S, and the discriminator loss L_{S} is used to optimize both parameters of the super-resolution model S and the parameters of the super-resolution discriminator D_{S}. The model pre-training process involves several rounds, and the above model pre-training process is performed in each round until the training termination condition is reached, so as to complete the training of the model.

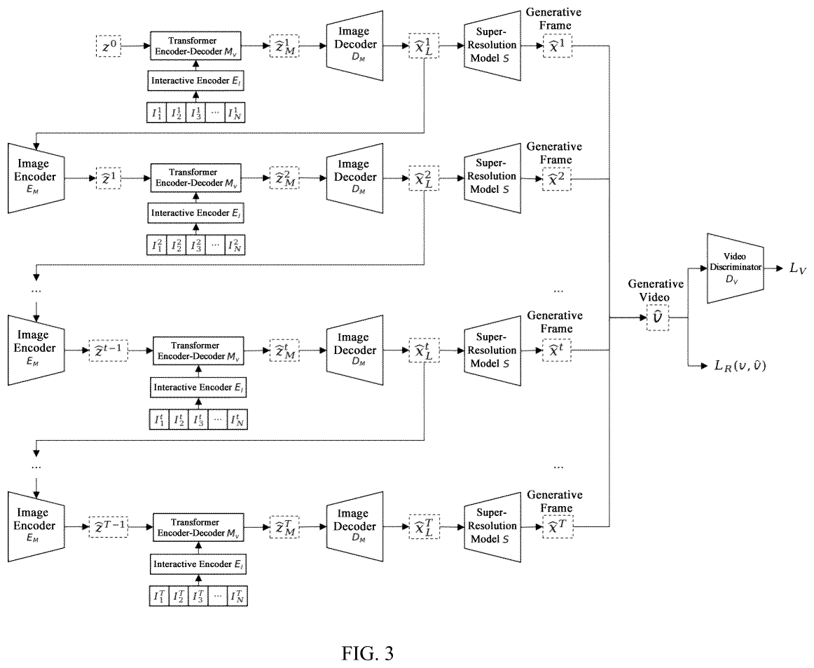

FIG. 3 is a schematic diagram illustrating data processing for training an interactive video generation model in a method for generating real-time target video of the present application.

Referring to FIG. 3, it can be seen that a scheme for training an interactive video generation model is described as follows.

The video pre-generation process (i.e., training of the interactive video generation model) includes: generating image hidden-layer feature corresponding to an initial frame of the low-resolution images; inputting the image hidden-layer feature and interactive information of the corresponding low-resolution image into a transformer of the interactive video generation model to generate target hidden-layer feature corresponding to a first frame image; performing image reconstruction on the target hidden-layer feature to obtain a reconstructed low-resolution image; and performing super-resolution processing on the reconstructed low-resolution image to obtain a pre-generated first frame image corresponding to a pre-generated video, and generating each of frame images corresponding to the pre-generated video based on the pre-generated first frame image corresponding to the pre-generated video, where a resolution of the pre-generated first frame image is the same as a resolution of the video data.

The Transformer encoder-decoder M_{V} and interactive encoder E₁ in FIG. 3 are considered as the transformers in the above.

The interactive video generation model contains components including: an interactive information encoder, a Transformer encoder-decoder M_{V}, an image encoder E_{M}, an image decoder D_{M} and a super-resolution model S. Among them, the image encoder E_{M}, the image decoder D_{M} and the super-resolution model S have been obtained by the pre-training process described above. Therefore, the process of training the interactive video generation model requires training only the interactive information encoder and the Transformer encoder-decoder M_{V}.

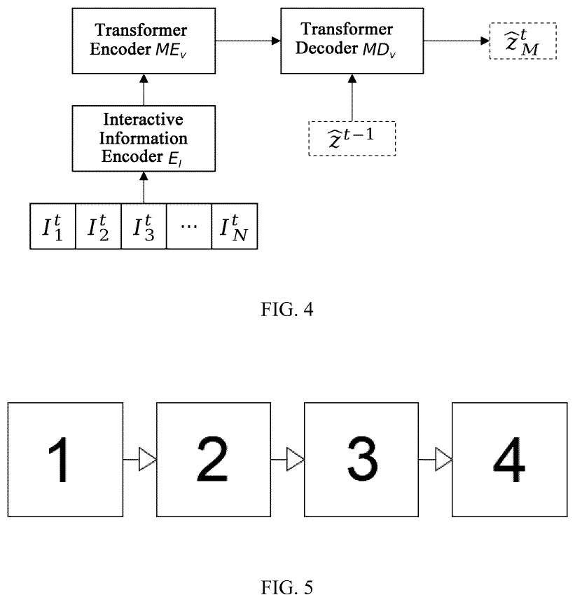

FIG. 4 is a schematic diagram illustrating data processing by the transformer in the training of an interactive video generation model of the present application.

Referring to FIG. 4, it can be seen further in some embodiments that, the transformer includes an interactive information encoder, a transformer encoder, and a transformer decoder, and thus the step of generating a target hidden-layer feature corresponding to the first frame image further includes: inputting the interactive information of the corresponding low-resolution image into the interactive information encoder to obtain an interactive hidden feature of the interactive information of the corresponding low-resolution image; and inputting the image hidden-layer feature into the transformer decoder, transmitting the interactive hidden feature to the transformer decoder through the transformer encoder, and generating the target hidden-layer feature of a corresponding image frame based on the interactive hidden feature and the image hidden-layer feature through the transformer decoder.

In order to avoid confusion, the transformer encoder ME_{V} in FIG. 4 is referred to as the transformer encoder and the Transformer decoder MD_{V} is referred to as the transformer decoder.

Exemplary, the interactive information encoder E₁ performs network feed-forward and nonlinear transformation on preprocessed interactive operation information I^{t} used as an input, so as to obtain the hidden-layer feature of the interactive operation information. The interactive information encoder E₁ includes basic neural network structures such as a convolutional layer, a fully connected layer, an activation layer, a pooling layer and a normalization layer. In FIG. 3 and FIG. 4, the inputs of the interactive information encoder E₁ are all interactive operation information I^{t}, i.e., the interactive operation information corresponding to a t^{th} frame of the video to be generated. In fact, according to different video generation tasks, the inputs of the interactive information encoder E₁ may be in various forms.

The different video tasks described above are classified into (1) offline tasks, where a set of known interactive operation information I=[I¹, . . . , I^{t}, . . . , I^{T}] is given, and a corresponding video v is generated directly using the known interactive operation information I, where T denotes a number of frames of the video to be generated, and t denotes the t^{th} frame of the generative video; and (2) real-time task, where the interactive information I=[I¹, . . . , I^{t}] of a history frame and a current frame is given, a video frame \hat{x}^{t} corresponding to a current moment t is generated, and the generative video frame is output in the form of video stream to realize real-time generation of the video.

For the offline task, since the interactive operation information corresponding to all frames are known, the interactive information encoder E₁ may use only the interactive operation information corresponding to the t^{th} frame, or it may also use the interactive information corresponding to the t^{th} frame and several frames around it, e.g., [ . . . , I^{t-2}, I^{t-1}, I^{t}, I^{t+1}, I^{t+2}, . . . ]. When interactive operation information of multiple frames is used, it is only needed to splice the interactive operation information of multiple frames in the temporal dimension.

For real-time tasks, since only the interactive operation information corresponding to the history frame and the current frame is known, the interactive information encoder E₁ may use only the interactive operation information corresponding to the t^{th} frame, or may also use the interactive information corresponding to the t^{th} frame and several frames around it, e.g., [ . . . , I^{t-2}, I^{t-1}, I^{t}]. When interactive operation information of multiple frames is used, it is only needed to splice the interactive operation information of multiple frames in the temporal dimension.

The structure of the Transformer encoder-decoder Mᵥ is a commonly used Transformer model, which will not be explained here. The Transformer encoder MEᵥ encodes the hidden-layer feature of the input interactive operation information and uses its internal self-attention mechanism to calculate the importance of each step of the time-series interactive operation information for generating a corresponding frame. The Transformer decoder MDᵥ uses output of the encoder MEᵥ as input and also uses the hidden-layer feature \hat{z}^{t-1} of the image generated in the previous frame as input. The generated previous frame image is input to the image encoder E_{M} to obtain the \hat{z}^{t-1}. The Transformer decoder MDᵥ functions to combine the interactive operation information with the information of the generated previous frame image to generate a hidden-layer feature

$${\hat{z}}_{M}^{t}$$

of a current frame, when is used for the image decoder D_{M} to generate a current frame image

$${\hat{x}}_{L}^{t} .$$

Then a definition of the image is improved through the super-resolution model S, and finally a generative frame \hat{x}^{t} of the current frame image is obtained.

Further, after the generation of a video clip is completed, the present embodiment further optimizes the scheme as follows: merging all generated image frames into the pre-generated video; calculating a reconstruction loss function of the pre-generated video and a real video corresponding to the video data, where the reconstruction loss function includes an MAE loss, an MSE loss, a perceptual loss and an image similarity loss; constructing a cross-entropy loss function, where the cross-entropy loss function is used to adjust parameters of a video discriminator, and the video discriminator is a component in the interactive video generation model for adjusting a definition of the pre-generated video to gradually approach the definition of the real video; and performing parameter adjustments of each component in the interactive video generation model by the reconstruction loss function and the cross-entropy loss function, where the performing parameter adjustments of each component in the interactive video generation model by the reconstruction loss function and the cross-entropy loss function includes: calculating a gradient for the parameters of each component in the interactive video generation model by the reconstruction loss function, and adjusting the parameters of each component in the interactive video generation model by means of gradient descent.

Specifically, in the present embodiment, for training the interactive information encoder E₁ and the Transformer encoder-decoder M_{V} of the interactive video generation model, the preprocessed interactive operation information is used as input, and a real video clip v corresponding to the interactive operation is used a supervisory information. Through the interactive video generation model, the generative video \hat{v} with the same resolution as the real video clip is output, and the reconstruction loss L_{R}(v, \hat{v}) between the generative video and the real video is calculated. The reconstruction loss function may use MAE loss (L₁ loss), MSE loss (L₂ loss), a perceptual loss, an image similarity loss, or any other loss function that may characterize differences in images. The reconstruction loss function is optimized to ensure that the video generated by the interactive video generation model has the same content as the real video.

Meanwhile, the video discriminator D_{V} is used to determine whether the input video is a real video or generative video, so that the definition of the video output from the interactive video generation model is close to the definition of the real video, where the principle and calculation formula of the loss function therefor are the same as that for the super-resolution discriminator D_{S}, and will not be repeated here. A difference between the video discriminator D_{V} and the super-resolution discriminator D_{S} lies in that a 2D image is used as the input to the super-resolution discriminator D_{S}, and a 3D video is used as the input to the video discriminator Dy. The video discriminator D_{V} is used for determining whether the input video is a real video or generative video, and is a model for binary classification, and therefore a cross-entropy loss function L_{V} in the same form as formula (1) may also be used for optimizing the video discriminator D_{V}.

After the above reconstruction loss L_{R} and the cross-entropy loss of the discriminator L_{V} are calculated, the back propagation process is performed. According to the calculated loss function, the gradient is calculated for the parameters of each component in the interactive video generation model, and the parameters of each component in the model are optimally updated using a gradient descent method. It should be noted that the above reconstruction loss L_{R} is used for optimizing only the interactive information encoder E₁ and the Transformer encoder-decoder M_{V}, and the discriminator loss function L_{V} is used for optimizing parameters of all of the interactive information encoder E₁, the Transformer encoder-decoder M_{V} and the video discriminator D_{V}. Parameters of the image encoder E_{M}, the image decoder D_{M} and the super-resolution model S are not updated during this training process. The model pre-training process includes several rounds, and the above model pre-training process is performed in each round until the training termination condition is reached, so as to complete the training of the interactive video generation model.

Referring to FIG. 3, it can be seen that a specific scheme for performing image reconstruction on the target hidden-layer feature to obtain a reconstructed low-resolution image includes: inputting the target hidden-layer feature into an image reconstruction decoder, and performing image reconstruction on the target hidden-layer feature through the image reconstruction decoder to obtain the reconstructed low-resolution image, where the image reconstruction decoder is a decoder for the trained low-resolution image reconstruction model.

Referring to FIG. 3, it can be seen that a specific scheme of performing super-resolution processing on the reconstructed low-resolution image to obtain a pre-generated first frame image corresponding to the pre-generated video includes: inputting the reconstructed low-resolution image into the trained super-resolution model S, and performing the super-resolution processing on the reconstructed low-resolution image through the super-resolution model S to obtain each of the frame images corresponding to the pre-generated video with the same resolution as the video data.

It is to be noted that, in order to reflect that the trained low-resolution image reconstruction model is included in the interactive video generation model, the image encoder E_{M} and the image decoder D_{M} in FIG. 3 are referred to as an image reconstruction encoder and an image reconstruction decoder in the description.

It should be noted that, when the pre-generated first frame image is generated, the generation of the subsequent image frames is dependent on the data of the previous frame image, by a specific scheme including: inputting, when generating a pre-generated t^{th} frame image, a (t−1)^{th} image frame into the image reconstruction encoder to obtain the image hidden-layer feature of the (t−1)^{th} image frame; acquiring interactive information corresponding to the (t−1)^{th} image frame and inputting the image hidden-layer feature and the interactive information corresponding to the (t−1)^{th} image frame into the transformer of the interactive video generation model to obtain target hidden-layer feature corresponding to the (t−1)^{th} image frame; inputting the target hidden-layer feature corresponding to the (t−1)^{th} image frame into an image reconstruction decoder, and performing image reconstruction on the target hidden-layer feature of the (t−1)^{th} image frame through the image reconstruction decoder to obtain a reconstructed low-resolution image corresponding to the (t−1)^{th} image frame; and inputting the reconstructed low-resolution image corresponding to the (t−1)^{th} image frame into the trained super-resolution model S, and performing the super-resolution processing on the reconstructed low-resolution image corresponding to the (t−1)^{th} image frame through the super-resolution model S to obtain a pre-generated (t−1)^{th} image frame.

Step S300 may be summarized as the following scheme including:
(1) generating a hidden-layer feature z⁰ of an initial frame, where there are two generation methods: \textcircled{1} In a process of pre-training the image reconstruction model, the hidden-layer features of all known images may be obtained, and the hidden-layer feature of one of the images is arbitrarily selected as the z⁰ (ii) After pre-training the image reconstruction model, a prior distribution of the hidden-layer features is known, and the z⁰ may be sampled from the prior distribution of the hidden-layer features;
(2) inputting the hidden-layer feature z¹⁰ of the initial frame and the hidden-layer feature of the interactive operation information I¹ corresponding to the first frame into the Transformer encoder-decoder M_{V} to obtain the hidden-layer feature

$${\hat{z}}_{M}^{1}$$

for reconstructing the first frame image; inputting the hidden-layer feature

$${\hat{z}}_{M}^{1}$$

into the image decoder D_{M} to obtain the reconstructed low-resolution image

$${\hat{x}}_{L}^{1} ;$$

and inputting

$${\hat{x}}_{L}^{1}$$

into the super-resolution model S to obtain the generated image generative frame \hat{x}¹ with original resolution, so that the generating of the first frame of the video is completed;
(3) inputting, for the t^{th} frame image of the generative video, the generated previous frame image \hat{x}^{t-1} of the video into the image encoder E_{M} first to obtain the hidden-layer encoding \hat{z}^{t-1} of the previous frame image \hat{x}^{t-1}; inputting \hat{z}^{t-1} and the hidden-layer feature of the interactive operation information I^{t} corresponding to a current frame into the Transformer encoder-decoder M_{V} to obtain the hidden-layer feature

$${\hat{z}}_{M}^{t}$$

for reconstruction the current frame image; inputting the hidden-layer feature

$${\hat{z}}_{M}^{t}$$

into the image decoder D_{M} to obtain the reconstructed low-resolution image

$${\hat{x}}_{L}^{t} ;$$

and inputting the

$${\hat{x}}_{L}^{t}$$

into the super-resolution model S to obtain the generative image \hat{x}^{t} with original resolution, so that the generating of the t^{th} frame of the video is completed;
(4) repeating step (3) until a termination condition is reached, where different video generation tasks have different termination conditions. For offline tasks, the termination condition is generally that a number of generative video frames reaches a preset value, then all the generative frames are merged as a video \hat{v}. For real-time tasks, the generative video frames are output to a video stream, where the termination condition is generally that the generation process is terminated by a user. A termination condition for the training process is that a number of frames of the generative video reaches a number of frames of the video clips for training.

Exemplarily, the present embodiment provides the following example of model training:
(1) A game is operated using the keyboard, where a keyboard operation is recorded while a video of the game is recorded, a duration of the video is 30 minutes, a resolution of the video is 512×512 pixels, a frame rate of the video is 30 frames/second, and a frame rate of the keyboard operation recording is 300 frames/second, i.e., each frame image of the video corresponds to 10 frames of the keyboard operation recording.
(2) down-sampling the video with an original resolution of 512×512 pixels to a resolution of 256×256 pixels; extracting all frame images from the original video with the resolution of 512×512 pixels, and extracting all frame images from the down-sampled video with the resolution of 256×256 pixels; cropping an entire video of 30 minutes into a number of video clips, where each of video clips contains 16 frames of images, and a cropping stride of 8 frames is between adjacent two video clips, and cropping the keyboard interactive recording data, where each video clip contains 160 frames of interactive data, and each frame image corresponds to 10 frames of interactive data; and performing Gaussian smoothing with a mean of 0 and a variance of 3 on the interactive data corresponding to each frame.
(3) training, by using the down-sampled frame image with a resolution of 256×256 pixels as input data and supervisory data, an image reconstruction model VQVAE to obtain an image encoder E_{M} and an image decoder D_{M}, and simultaneously obtain a prior distribution of image hidden-layer feature;
(4) training a SwinIR super-resolution model S by using the down-sampled frame image with a resolution of 256×256 pixels as input data and using the frame image with an original resolution of 512× 512 pixels as supervisory data;
(5) extracting the hidden-layer feature from the generated previous frame image (the hidden-layer feature of the initial frame is obtained by sampling from the prior distribution of the hidden-layer features of the images obtained by pre-training of the VQVAE) by using the encoder of VQVAE; inputting the interactive operation information with a duration of 10 corresponding to the current frame into an interactive information encoder to obtain an interactive information hidden-layer feature; and inputting the generated hidden-layer feature of the previous frame image and the interactive information hidden-layer feature into the Transformer encoder-decoder M_{V} to generate the hidden-layer feature of the current frame image; input the hidden-layer feature of the current frame image into the image decoder D_{M} to generate the low-resolution image of the current frame having a resolution as 256×256 pixels; then inputting the low-resolution image into the pre-trained SwinIR super-resolution model S to obtain an image with an original resolution of 512×512 pixels, i.e., the generated current frame image;
(6) repeating the process of (5) for 16 times to obtain the generative video clips; using the generative video clips and the real video clips to calculate the related loss functions, so as to optimize the parameters of the interactive information encoder and the Transformer encoder-decoder M_{V} until the training is terminated, i.e., the trained interactive video generation model is obtained.

S400, obtaining an interactive target video through the trained interactive video generation model and input data. Specifically, in the present embodiment, the data processing processes of the interactive video generation model in the process of generating the interactive video includes processes as follows:
\textcircled{1} the calculation processes of the interactive information encoder and Transformer encoder-decoder M_{V} may be placed in a single process with an input queue using an output queue in the process \textcircled{4}, and an output queue of the process is created;
\textcircled{2} an operation process of the image decoder D_{M} may be placed in a process with an input queue using the output queue of the process \textcircled{1}, and an output queue of the operation process of the image decoder D_{M} is created;
\textcircled{3} an operation process of the super-resolution model S may be placed in a process with an input queue using the output queue of the process \textcircled{2}, and an output queue of the operation process of the super-resolution model S is created;
\textcircled{4} an operation process of the image encoder E_{M} may be placed in a process with an input queue using the output queue of the process \textcircled{2}, and the output queue of the operation process of the image encoder E_{M} is created;
\textcircled{5} the final video output process is placed in a process with an input queue using the output queue of the process \textcircled{3}, where each frame of the generated images is output to a video file or video stream.

The real-time performance of an inference process of the model may be enhanced by running in parallel.

Exemplarily, the present embodiment provides the following example of generating an interactive video:
(1) providing a set of interactive operation sequences of a known duration, where the duration is 3000 frames, a number of frames of a corresponding generative video thereof is 300 frames, and a duration of the video is 10 seconds;
(2) sampling a hidden-layer feature of an initial frame from a prior distribution of image hidden-layer features obtained by pre-training VQVAE; inputting the hidden-layer feature of the initial frame and interactive operation information corresponding to the generated first frame image into a Transformer encoder-decoder M_{V} parameter to obtain hidden-layer feature of the first frame image, and then inputting it into the VQVAE decoder to obtain a generated first frame image with low resolution; and inputting the low-resolution image into a SwinIR super-resolution model S to obtain a generated first frame image with the original resolution, which is a first frame image of the generative video;
(3) inputting, starting from a generation of a second frame image, the generated previous frame image with low resolution into the VQVAE encoder first to obtain the hidden-layer feature of the previous frame image, and then generating, in combination with the interactive information operation corresponding to a generation of a current frame image and sequentially through the Transformer encoder-decoder M_{V} parameter, VQVAE decoder, and the SwinIR super-resolution model S, the current frame image with original resolution;
(4) repeating step (2) until 300 frames of video images are generated, and integrating the generated 300 frames of images into a generative video and output it for saving.

FIG. 5 is a schematic diagram illustrating a system for generating real-time target video of the present application.

Referring to FIG. 5, it can be seen that the present embodiment further provides a system for generating real-time target video, including:
a data acquisition module 1, configured to acquire training data including interactive information and video data corresponding to the interactive information. Specifically, in the present embodiment, the data acquisition module 1 is configured to perform all logical flows for acquiring the training data in the above method for generating real-time target video;
a data preprocessing module 2, configured to preprocess the training data to obtain target training data; where the preprocessing includes: performing down-sampling processing on the video data to obtain a plurality of frames of low-resolution images; where the target training data is used to indicate the low-resolution images and the interactive information corresponding to the low-resolution images. Specifically, in the present embodiment, the data preprocessing module 2 is configured to realize all logical flows of preprocessing the training data in the above method for real-time interactive video generation;
a model training module 3, configured to perform model training to a preset model based on the target training data, where the preset model includes a low-resolution image reconstruction model and a super-resolution model for images; the model training includes a model pre-training process and a video pre-generation process, the model pre-training process includes a training of a low-resolution image reconstruction model and a training of a super-resolution model, and the video pre-generation process includes: performing video pre-generation based on the target training data and an interactive video generation model to complete training to the interactive video generation model, where the interactive video generation model includes the pre-trained low-resolution image reconstruction model and the pre-trained super-resolution model for images. Specifically, in the present embodiment, the model training module 3 is configured to realizs all logical flows for performing model training in the above method for real-time interactive video generation; and
a video generation module 4, including the trained interactive video generation model, where the trained interactive video generation model includes the trained resolution image reconstruction model and the trained super-resolution model, where the video generation module 4 is configured to obtain an interactive target video through the trained interactive video generation model and input data. Specifically, in the present embodiment, the video generation module 4 is configured to implement all logical flows for carrying out the generation of the interactive video in the above method for real-time interactive video generation.

In some embodiments, the data preprocessing module 2 is configured to:
down-sample the video data to obtain low-resolution images, where a ratio of the down-sampling for reducing resolution is determined according to a size of a frame image of the video data;
crop the low-resolution images to obtain several groups of video clips, where each of the video clips includes T frames, a stride of T/2 frames is presented between adjacent two of the video clips, and adjacent two of the video clips overlap by T/2 frames; and
record corresponding interactive information for each of the video clips to obtain the target training data, where a frame rate of the interactive information recorded for each of the video clips is not less than a number of frames of the corresponding video clip, and the frame rate of the interactive information recorded for each of the video clips is an integer times of the number of the frames of the corresponding video clip.

In some embodiments, when recording corresponding interactive information for each of the video clips, the data preprocessing module 2 is configured to perform Gaussian smoothing on the corresponding interactive information recorded in the video clip in a temporal dimension.

In some embodiments, the model training module 3 is further configured to:
generate an image hidden-layer feature corresponding to an initial frame of the low-resolution images;
input the image hidden-layer feature and interactive information corresponding to the low-resolution image into a transformer of the interactive video generation model, to generate a target hidden-layer feature corresponding to a first frame image;
perform image reconstruction on the target hidden-layer feature to obtain the reconstructed low-resolution image; and
perform a super-resolution processing on the reconstructed low-resolution image to obtain a pre-generated first frame image corresponding to the pre-generated video, and generate each of the frame images corresponding to the pre-generated video based on the pre-generated first frame image corresponding to the pre-generated video, where a resolution of the pre-generated first frame image is same as a resolution of the video data.

In some embodiments, the generating an image hidden-layer feature corresponding to an initial frame of the low-resolution images includes a first approach and a second approach, where the model training module 3 is configured to:
acquire, when performing the first approach, hidden-layer features of all images in a process of training the low-resolution image reconstruction model, and select any one feature among all of the hidden-layer features as the image hidden-layer feature; and
sample, when performing the second approach after the training of the low-resolution image reconstruction model, from a priori distribution of all of the hidden-layer features to obtain the image hidden-layer feature.

In some embodiments, the model training module 3 is further configured to:
input the target hidden-layer feature into an image reconstruction decoder, and perform image reconstruction on the target hidden-layer feature through the image reconstruction decoder to obtain the reconstructed low-resolution image, where the image reconstruction decoder is a decoder for the trained low-resolution image reconstruction model; and
input the reconstructed low-resolution image into the trained super-resolution model, and perform a super-resolution processing on the reconstructed low-resolution image through the super-resolution model, to obtain each of the frame images corresponding to the pre-generated video having a resolution same as that of the video data.

In some embodiments, the model training module 3 is further configured to:
input, when generating a pre-generated t^{th} frame image, a (t−1)^{th} image frame into the image reconstruction encoder to obtain an image hidden-layer feature of the (t−1)^{th} image frame;
acquire interactive information corresponding to the (t−1)^{th} image frame and inputting the image hidden-layer feature and the interactive information corresponding to the (t−1)^{th} image frame into the transformer of the interactive video generation model, to obtain a target hidden-layer feature corresponding to the (t−1)^{th} image frame;
input the target hidden-layer feature corresponding to the (t−1)^{th} image frame into an image reconstruction decoder, and perform image reconstruction on the target hidden-layer feature of the (t−1)^{th} image frame through the image reconstruction decoder, to obtain a reconstructed low-resolution image corresponding to the (t−1)^{th} image frame; and
input the reconstructed low-resolution image corresponding to the (t−1)^{th} image frame into the trained super-resolution model, and perform the super-resolution processing on the reconstructed low-resolution image corresponding to the (t−1)^{th} image frame through the super-resolution model, to obtain a pre-generated (t−1)^{th} image frame.

In some embodiments, the transformer includes an interactive information encoder, a transformer encoder and a transformer decoder, and the model training module 3 is further configured to:
input the interactive information of the corresponding low-resolution image into the interactive information encoder to obtain an interactive hidden feature of the interactive information of the corresponding low-resolution image; and
input the image hidden-layer feature into the transformer decoder, transmit the interactive hidden feature to the transformer decoder through the transformer encoder, and generate the target hidden-layer feature of a corresponding image frame based on the interactive hidden feature and the image hidden-layer feature through the transformer decoder.

In some embodiments, the model training module 3 is further configured to:
merge all of the generated image frames into the pre-generated video;
calculate a reconstruction loss function of the pre-generated video and a real video corresponding to the video data, where the reconstruction loss function includes MAE loss, MSE loss, perceptual loss, and image similarity loss;
construct a cross-entropy loss function, where the cross-entropy loss function is used to adjust parameters of a video discriminator, and the video discriminator is a component in the interactive video generation model for adjusting a definition of the pre-generated video to gradually approach the definition of the real video; and
perform parameter adjustments on respective ones of components in the interactive video generation model by the reconstruction loss function and the cross-entropy loss function.

In some embodiments, when performing parameter adjustments on respective ones of components in the interactive video generation model by the reconstruction loss function and the cross-entropy loss function, the model training module 3 is configured to: calculate a gradient for the parameters of the respective ones of components in the interactive video generation model by the reconstruction loss function, and adjust the parameters of the respective ones of components in the interactive video generation model by means of gradient descent.

The embodiments have the following advantages.

The real-time interactive information is used as a condition for generation of low-resolution video frame, and a super-resolution model is used to improve a size of the generated low-resolution frame image to obtain a clear video frame image with high resolution. The processes of generating low-resolution video frame images and improving the definition of video frame images by super-resolution may be performed in parallel to output the generated video stream in real time.

1. A method for generating real-time target interactive video, comprising following steps:
acquiring training data comprising interactive information and video data corresponding to the interactive information;
preprocessing the training data to obtain target training data;
performing model training based on the target training data, wherein the model training comprises a model pre-training process and a video pregenerating process, the model pre-training process comprises a training of a low-resolution image reconstruction model and a training of a super-resolution model, and the video pregenerating process comprises: performing a pre-generation of a video based on an interactive video generation model to complete a training of the interactive video generation model, so that the trained interactive video generation model comprises the trained low-resolution image reconstruction model and the trained super-resolution model; and
generating an interactive video by using the trained interactive video generation model;
wherein the video pregenerating process comprises:
generating an image hidden-layer feature corresponding to an initial frame of a low-resolution image;
inputting the image hidden-layer feature and interactive information corresponding to the low-resolution image into a transformer of the interactive video generation model, to generate a target hidden-layer feature corresponding to a first frame image;
inputting the target hidden-layer feature into an image reconstruction decoder, and performing image reconstruction on the target hidden-layer feature through the image reconstruction decoder to obtain the reconstructed low-resolution image, wherein the image reconstruction decoder is a decoder for the trained low-resolution image reconstruction model; and
inputting the reconstructed low-resolution image into the trained super-resolution model, and performing a super-resolution processing on the reconstructed low-resolution image through the super-resolution model, to obtain each of the frame images corresponding to the pre-generated video having a resolution same as that of the video data.

2. The method for generating real-time interactive video according to claim 1, wherein the step of preprocessing the training data comprises:
down-sampling the video data to obtain the low-resolution image, wherein a ratio of the down-sampling for reducing resolution is determined according to a size of a frame image of the video data;
cropping the low-resolution image to obtain several groups of video clips, wherein each of the video clips comprises T frames, a stride of 2/T frames is presented between adjacent two of the video clips, and adjacent two of the video clips overlap by 2/T frames; and
recording corresponding interactive information for each of the video clips to obtain the target training data, wherein a frame rate of the interactive information recorded for each of the video clips is not less than a number of frames of the corresponding video clip, and the frame rate of the interactive information recorded for each of the video clips is an integer times of the number of the frames of the corresponding video clip.

3. The method for generating real-time interactive video according to claim 2, wherein the recording corresponding interactive information for each of the video clips comprises: performing Gaussian smoothing on the corresponding interactive information recorded in the video clip in a temporal dimension.

4. (canceled)

5. The method for generating real-time interactive video according to claim 1, wherein the generating an image hidden-layer feature corresponding to an initial frame of the low-resolution image comprises a first approach and a second approach, wherein
the first approach comprises acquiring hidden-layer features of all images in a process of training the low-resolution image reconstruction model, and selecting any one feature among all of the hidden-layer features as the image hidden-layer feature; and
the second approach comprises sampling, after the training of the low-resolution image reconstruction model, from a priori distribution of all of the hidden-layer features to obtain the image hidden-layer feature.

6. (canceled)

7. The method for generating real-time interactive video according to claim 1, wherein the video pregenerating process further comprises:
inputting, when generating a pre-generated t^{th} frame image, a (t−1)^{th} image frame into the image reconstruction encoder to obtain an image hidden-layer feature of the (t−1)^{th} image frame;
acquiring interactive information corresponding to the (t−1)^{th} image frame and inputting the image hidden-layer feature and the interactive information corresponding to the (t−1)^{th} image frame into the transformer of the interactive video generation model, to obtain a target hidden-layer feature corresponding to the (t−1)^{th} image frame;
inputting the target hidden-layer feature corresponding to the (t−1)^{th} image frame into an image reconstruction decoder, and performing image reconstruction on the target hidden-layer feature of the (t−1)^{th} image frame through the image reconstruction decoder, to obtain a reconstructed low-resolution image corresponding to the (t−1)^{th} image frame; and
inputting the reconstructed low-resolution image corresponding to the (t−1)^{th} image frame into the trained super-resolution model, and performing the super-resolution processing on the reconstructed low-resolution image corresponding to the (t−1)^{th} image frame through the super-resolution model, to obtain a pre-generated (t−1)^{th} image frame.

8. The method for generating real-time interactive video according to claim 1, wherein the transformer comprises an interactive information encoder, a transformer encoder and a transformer decoder, and the video pregenerating process further comprises:
inputting the interactive information of the corresponding low-resolution image into the interactive information encoder to obtain an interactive hidden feature of the interactive information of the corresponding low-resolution image; and
inputting the image hidden-layer feature into the transformer decoder, transmitting the interactive hidden feature to the transformer decoder through the transformer encoder, and generating the target hidden-layer feature of a corresponding image frame based on the interactive hidden feature and the image hidden-layer feature through the transformer decoder.

9. The method for generating real-time interactive video according to claim 1, wherein the video pregenerating process further comprises:
merging all of the generated image frames into the pre-generated video;
calculating a reconstruction loss function of the pre-generated video and a real video corresponding to the video data, wherein the reconstruction loss function comprises MAE loss, MSE loss, perceptual loss, and image similarity loss;
constructing a cross-entropy loss function, wherein the cross-entropy loss function is used to adjust parameters of a video discriminator, and the video discriminator is a component in the interactive video generation model for adjusting a definition of the pre-generated video to gradually approach the definition of the real video; and
performing parameter adjustments on respective ones of components in the interactive video generation model by the reconstruction loss function and the cross-entropy loss function.

10. The method for generating real-time interactive video according to claim 9, wherein the performing parameter adjustments on respective ones of components in the interactive video generation model by the reconstruction loss function and the cross-entropy loss function comprises: calculating a gradient for the parameters of the respective ones of components in the interactive video generation model by the reconstruction loss function, and adjusting the parameters of the respective ones of components in the interactive video generation model by means of gradient descent.

11. A system for generating real-time interactive video, applicable for the method for generating real-time interactive video according to claim 1, comprising:
a data acquisition module, configured to acquire training data comprising interactive information and video data corresponding to the interactive information;
a data preprocessing module, configured to preprocess the training data to obtain target training data;
a model training module, configured to perform model training based on the target training data, wherein the model training comprises a model pre-training process and a video pre-generation process, the model pre-training process comprises a training of a low-resolution image reconstruction model and a training of a super-resolution model, and the video pre-generation process comprises performing a pre-generation of a video based on an interactive video generation model to complete a training of the interactive video generation model, so that the trained interactive video generation model comprises the trained low-resolution image reconstruction model and the trained super-resolution model; and
a video generation module, comprising the trained interactive video generation model, wherein the trained interactive video generation model comprises the trained resolution image reconstruction model and the trained super-resolution model, wherein the video generation module is configured to generate an interactive video by using the trained interactive video generation model;
wherein the model training module is further configured to:
generate an image hidden-layer feature corresponding to an initial frame of a low-resolution image;
input the image hidden-layer feature and interactive information corresponding to the low-resolution image into a transformer of the interactive video generation model, to generate a target hidden-layer feature corresponding to a first frame image;
input the target hidden-layer feature into an image reconstruction decoder, and perform image reconstruction on the target hidden-layer feature through the image reconstruction decoder to obtain the reconstructed low-resolution image, wherein the image reconstruction decoder is a decoder for the trained low-resolution image reconstruction model; and
input the reconstructed low-resolution image into the trained super-resolution model, and perform a super-resolution processing on the reconstructed low-resolution image through the super-resolution model, to obtain each of the frame images corresponding to the pre-generated video having a resolution same as that of the video data.

12-20. (canceled)

21. A system for generating real-time interactive video, applicable for the method for generating real-time interactive video according to claim 2, comprising:
a data acquisition module, configured to acquire training data comprising interactive information and video data corresponding to the interactive information;
a data preprocessing module, configured to preprocess the training data to obtain target training data;
a model training module, configured to perform model training based on the target training data, wherein the model training comprises a model pre-training process and a video pre-generation process, the model pre-training process comprises a training of a low-resolution image reconstruction model and a training of a super-resolution model, and the video pre-generation process comprises performing a pre-generation of a video based on an interactive video generation model to complete a training of the interactive video generation model, so that the trained interactive video generation model comprises the trained low-resolution image reconstruction model and the trained super-resolution model; and
a video generation module, comprising the trained interactive video generation model, wherein the trained interactive video generation model comprises the trained resolution image reconstruction model and the trained super-resolution model, wherein the video generation module is configured to generate an interactive video by using the trained interactive video generation model;
wherein the model training module is further configured to:
generate an image hidden-layer feature corresponding to an initial frame of a low-resolution image;
input the image hidden-layer feature and interactive information corresponding to the low-resolution image into a transformer of the interactive video generation model, to generate a target hidden-layer feature corresponding to a first frame image;
input the target hidden-layer feature into an image reconstruction decoder, and perform image reconstruction on the target hidden-layer feature through the image reconstruction decoder to obtain the reconstructed low-resolution image, wherein the image reconstruction decoder is a decoder for the trained low-resolution image reconstruction model; and
input the reconstructed low-resolution image into the trained super-resolution model, and perform a super-resolution processing on the reconstructed low-resolution image through the super-resolution model, to obtain each of the frame images corresponding to the pre-generated video having a resolution same as that of the video data.

22. A system for generating real-time interactive video, applicable for the method for generating real-time interactive video according to claim 3, comprising:
a data acquisition module, configured to acquire training data comprising interactive information and video data corresponding to the interactive information;
a data preprocessing module, configured to preprocess the training data to obtain target training data;
a model training module, configured to perform model training based on the target training data, wherein the model training comprises a model pre-training process and a video pre-generation process, the model pre-training process comprises a training of a low-resolution image reconstruction model and a training of a super-resolution model, and the video pre-generation process comprises performing a pre-generation of a video based on an interactive video generation model to complete a training of the interactive video generation model, so that the trained interactive video generation model comprises the trained low-resolution image reconstruction model and the trained super-resolution model; and
a video generation module, comprising the trained interactive video generation model, wherein the trained interactive video generation model comprises the trained resolution image reconstruction model and the trained super-resolution model, wherein the video generation module is configured to generate an interactive video by using the trained interactive video generation model;
wherein the model training module is further configured to:
generate an image hidden-layer feature corresponding to an initial frame of a low-resolution image;
input the image hidden-layer feature and interactive information corresponding to the low-resolution image into a transformer of the interactive video generation model, to generate a target hidden-layer feature corresponding to a first frame image;
input the target hidden-layer feature into an image reconstruction decoder, and perform image reconstruction on the target hidden-layer feature through the image reconstruction decoder to obtain the reconstructed low-resolution image, wherein the image reconstruction decoder is a decoder for the trained low-resolution image reconstruction model; and
input the reconstructed low-resolution image into the trained super-resolution model, and perform a super-resolution processing on the reconstructed low-resolution image through the super-resolution model, to obtain each of the frame images corresponding to the pre-generated video having a resolution same as that of the video data.

23. A system for generating real-time interactive video, applicable for the method for generating real-time interactive video according to claim 5, comprising:
a data acquisition module, configured to acquire training data comprising interactive information and video data corresponding to the interactive information;
a data preprocessing module, configured to preprocess the training data to obtain target training data;
a model training module, configured to perform model training based on the target training data, wherein the model training comprises a model pre-training process and a video pre-generation process, the model pre-training process comprises a training of a low-resolution image reconstruction model and a training of a super-resolution model, and the video pre-generation process comprises performing a pre-generation of a video based on an interactive video generation model to complete a training of the interactive video generation model, so that the trained interactive video generation model comprises the trained low-resolution image reconstruction model and the trained super-resolution model; and
a video generation module, comprising the trained interactive video generation model, wherein the trained interactive video generation model comprises the trained resolution image reconstruction model and the trained super-resolution model, wherein the video generation module is configured to generate an interactive video by using the trained interactive video generation model;
wherein the model training module is further configured to:
generate an image hidden-layer feature corresponding to an initial frame of a low-resolution image;
input the image hidden-layer feature and interactive information corresponding to the low-resolution image into a transformer of the interactive video generation model, to generate a target hidden-layer feature corresponding to a first frame image;
input the target hidden-layer feature into an image reconstruction decoder, and perform image reconstruction on the target hidden-layer feature through the image reconstruction decoder to obtain the reconstructed low-resolution image, wherein the image reconstruction decoder is a decoder for the trained low-resolution image reconstruction model; and
input the reconstructed low-resolution image into the trained super-resolution model, and perform a super-resolution processing on the reconstructed low-resolution image through the super-resolution model, to obtain each of the frame images corresponding to the pre-generated video having a resolution same as that of the video data.

24. A system for generating real-time interactive video, applicable for the method for generating real-time interactive video according to claim 7, comprising:
a data acquisition module, configured to acquire training data comprising interactive information and video data corresponding to the interactive information;
a data preprocessing module, configured to preprocess the training data to obtain target training data;
a model training module, configured to perform model training based on the target training data, wherein the model training comprises a model pre-training process and a video pre-generation process, the model pre-training process comprises a training of a low-resolution image reconstruction model and a training of a super-resolution model, and the video pre-generation process comprises performing a pre-generation of a video based on an interactive video generation model to complete a training of the interactive video generation model, so that the trained interactive video generation model comprises the trained low-resolution image reconstruction model and the trained super-resolution model; and
a video generation module, comprising the trained interactive video generation model, wherein the trained interactive video generation model comprises the trained resolution image reconstruction model and the trained super-resolution model, wherein the video generation module is configured to generate an interactive video by using the trained interactive video generation model;
wherein the model training module is further configured to:
generate an image hidden-layer feature corresponding to an initial frame of a low-resolution image;
input the image hidden-layer feature and interactive information corresponding to the low-resolution image into a transformer of the interactive video generation model, to generate a target hidden-layer feature corresponding to a first frame image;
input the target hidden-layer feature into an image reconstruction decoder, and perform image reconstruction on the target hidden-layer feature through the image reconstruction decoder to obtain the reconstructed low-resolution image, wherein the image reconstruction decoder is a decoder for the trained low-resolution image reconstruction model; and
input the reconstructed low-resolution image into the trained super-resolution model, and perform a super-resolution processing on the reconstructed low-resolution image through the super-resolution model, to obtain each of the frame images corresponding to the pre-generated video having a resolution same as that of the video data.

25. A system for generating real-time interactive video, applicable for the method for generating real-time interactive video according to claim 8, comprising:
a data acquisition module, configured to acquire training data comprising interactive information and video data corresponding to the interactive information;
a data preprocessing module, configured to preprocess the training data to obtain target training data;
a model training module, configured to perform model training based on the target training data, wherein the model training comprises a model pre-training process and a video pre-generation process, the model pre-training process comprises a training of a low-resolution image reconstruction model and a training of a super-resolution model, and the video pre-generation process comprises performing a pre-generation of a video based on an interactive video generation model to complete a training of the interactive video generation model, so that the trained interactive video generation model comprises the trained low-resolution image reconstruction model and the trained super-resolution model; and
a video generation module, comprising the trained interactive video generation model, wherein the trained interactive video generation model comprises the trained resolution image reconstruction model and the trained super-resolution model, wherein the video generation module is configured to generate an interactive video by using the trained interactive video generation model;
wherein the model training module is further configured to:
generate an image hidden-layer feature corresponding to an initial frame of a low-resolution image;
input the image hidden-layer feature and interactive information corresponding to the low-resolution image into a transformer of the interactive video generation model, to generate a target hidden-layer feature corresponding to a first frame image;
input the target hidden-layer feature into an image reconstruction decoder, and perform image reconstruction on the target hidden-layer feature through the image reconstruction decoder to obtain the reconstructed low-resolution image, wherein the image reconstruction decoder is a decoder for the trained low-resolution image reconstruction model; and
input the reconstructed low-resolution image into the trained super-resolution model, and perform a super-resolution processing on the reconstructed low-resolution image through the super-resolution model, to obtain each of the frame images corresponding to the pre-generated video having a resolution same as that of the video data.

26. A system for generating real-time interactive video, applicable for the method for generating real-time interactive video according to claim 9, comprising:
a data acquisition module, configured to acquire training data comprising interactive information and video data corresponding to the interactive information;
a data preprocessing module, configured to preprocess the training data to obtain target training data;
a model training module, configured to perform model training based on the target training data, wherein the model training comprises a model pre-training process and a video pre-generation process, the model pre-training process comprises a training of a low-resolution image reconstruction model and a training of a super-resolution model, and the video pre-generation process comprises performing a pre-generation of a video based on an interactive video generation model to complete a training of the interactive video generation model, so that the trained interactive video generation model comprises the trained low-resolution image reconstruction model and the trained super-resolution model; and
a video generation module, comprising the trained interactive video generation model, wherein the trained interactive video generation model comprises the trained resolution image reconstruction model and the trained super-resolution model, wherein the video generation module is configured to generate an interactive video by using the trained interactive video generation model;
wherein the model training module is further configured to:
generate an image hidden-layer feature corresponding to an initial frame of a low-resolution image;
input the image hidden-layer feature and interactive information corresponding to the low-resolution image into a transformer of the interactive video generation model, to generate a target hidden-layer feature corresponding to a first frame image;
input the target hidden-layer feature into an image reconstruction decoder, and perform image reconstruction on the target hidden-layer feature through the image reconstruction decoder to obtain the reconstructed low-resolution image, wherein the image reconstruction decoder is a decoder for the trained low-resolution image reconstruction model; and
input the reconstructed low-resolution image into the trained super-resolution model, and perform a super-resolution processing on the reconstructed low-resolution image through the super-resolution model, to obtain each of the frame images corresponding to the pre-generated video having a resolution same as that of the video data.

27. A system for generating real-time interactive video, applicable for the method for generating real-time interactive video according to claim 10, comprising:
a data acquisition module, configured to acquire training data comprising interactive information and video data corresponding to the interactive information;
a data preprocessing module, configured to preprocess the training data to obtain target training data;
a model training module, configured to perform model training based on the target training data, wherein the model training comprises a model pre-training process and a video pre-generation process, the model pre-training process comprises a training of a low-resolution image reconstruction model and a training of a super-resolution model, and the video pre-generation process comprises performing a pre-generation of a video based on an interactive video generation model to complete a training of the interactive video generation model, so that the trained interactive video generation model comprises the trained low-resolution image reconstruction model and the trained super-resolution model; and
a video generation module, comprising the trained interactive video generation model, wherein the trained interactive video generation model comprises the trained resolution image reconstruction model and the trained super-resolution model, wherein the video generation module is configured to generate an interactive video by using the trained interactive video generation model;
wherein the model training module is further configured to:
generate an image hidden-layer feature corresponding to an initial frame of a low-resolution image;
input the image hidden-layer feature and interactive information corresponding to the low-resolution image into a transformer of the interactive video generation model, to generate a target hidden-layer feature corresponding to a first frame image;
input the target hidden-layer feature into an image reconstruction decoder, and perform image reconstruction on the target hidden-layer feature through the image reconstruction decoder to obtain the reconstructed low-resolution image, wherein the image reconstruction decoder is a decoder for the trained low-resolution image reconstruction model; and
input the reconstructed low-resolution image into the trained super-resolution model, and perform a super-resolution processing on the reconstructed low-resolution image through the super-resolution model, to obtain each of the frame images corresponding to the pre-generated video having a resolution same as that of the video data.
